(19) United States
(12) Patent Application Publication
(10) Pub. No.: US 2026/0172157 A1
(43) Pub. Date: Jun. 18, 2026

(54) DETERMINATION AND TRANSMISSION OF WAKEUP SIGNAL

(71) Applicant: Telefonaktiebolaget LM Ericsson (PUBL), Stockholm (SE)

(72) Inventors: Andres Reial, HÖLLVIKEN (SE); Sina Maleki, MALMÖ (SE); Ali Nader, MALMÖ (SE); Pål Frenger, LINKÖPING (SE); Ajit Nimbalker, FREMONT, CA (US)

(21) Appl. No.: 19/126,123

(22) PCT Filed: Nov. 3, 2023
(86) PCT No.: PCT/SE2023/051121

§ 371 Date: Apr. 30, 2025

Related U.S. Application Data
(60) Provisional application No. 63/422,516, filed on Nov. 4, 2022.

(51) Int. Cl. H04L 5/00

(52) U.S. Cl. CPC H04L 5/0007; H04L 5/0048; H04L 5/0053

(57) ABSTRACT

A wireless communication device receives (210) a discovery signal and transmits (240) a wake-up signal, WUS, based on a WUS configuration. The WUS configuration is based on the discovery signal. The WUS configuration comprises one or more of a WUS permitted indicator or flag, a number of WUS attempts to be made if a network node does not respond to the WUS, a periodicity to be used for WUS attempts if a network node does not respond to the WUS, a prohibition timer to be applied before making a second attempt to transmit the WUS if a network node does not respond to the WUS, a response time/window during which to receive a response to the WUS.

### TECHNICAL FIELD

The present disclosure generally relates to wireless communication, and in particular to a wakeup signal for a wireless communication device to wake up a network node.

### BACKGROUND

### Network (NW) Energy Consumption

NW energy consumption in new radio (NR) increases with respect to long term evolution (LTE) due to more complex hardware (HW), e.g., higher bandwidth (BW) and a greater number of antennas. This is particularly more evident when the NW operates in higher frequencies. Hence it is important for the NW to turn ON/OFF unused HW modules during inactivity times. For example, in frequency range 2 (FR2), an NR base station (gNB) can be configured with up to 64 beams and transmit up to 64 synchronization signal blocks (SSBs). This implies 64 ports with many transceiver chains involved. Such SSBs are transmitted every 20 ms in during 5 ms windows for the sake of providing coverage to potential user equipments (UEs) even if there actually are no UEs present in the cell. Another example of energy costly always-on broadcast transmissions is system information block 1 (SIB1) which is typically transmitted (per beam) every 20/40 ms.

SSB and SIB1 configurations

An NR gNB can be configured with up to 64 SSBs. The configured SSBs in a cell for UEs in radio resource control (RRC) IDLE/INACTIVE have all the same periodicity and output power. The gNB can provide information to the UEs about how many/which SSBs that are active (present) within the serving cell and neighboring cells. The SSB consists of a primary synchronization signal (PSS), a secondary synchronization signal (SSS) and the physical broadcast channel (PBCH).

The gNB can further provide information about the rate/periodicity at which these SSBs are provided on cell level. For the serving cell, the parameter ssb-PositionsInBurst indicates which of the SSBs that are active, and the parameter ssb-PeriodicityServingCell specifies the rate/periodicity of them. Furthermore, the UEs are informed about the SSBs output power via the common parameter ss-PBCH-BlockPower. When it comes to neighbor cells, a gNB can specify the neighboring active (present) SSBs via the parameter ssb-ToMeasure and the associated rate/periodicity via the SSB Measurement Timing Configuration (SMTC) which defines the time window during which the UE measures the SSBs belonging to these neighboring cells. The UE makes certain assumptions for a standalone NR cell upon the cell selection procedure. Even though the periodicity of the SSB is configurable, the UE upon initial cell selection expects that the SSB is provided every 20 ms in that cell. Furthermore, the UE expects that SIB1 is transmitted in every beam (corresponding to every SSB) of the cell. For example, for a 64-beams/SSB configuration, the UE expects that SIB1 is broadcast/swept in 64 beams. The transmission period of SIB1 is typically between 20 and 40 ms. For example, every 20 ms, 64 instances of SIB1 may be transmitted by the gNB. The master information block (MIB) is part of the SSB. Together with SIB1 they are called Minimum System Information (Minimum SI). If the UE cannot determine the full contents of the minimum SI of a cell by receiving from that cell, the UE shall consider that cell as barred. Other system information (OSI), i.e., SIBs 2, 3, . . . carried in SI containers, are also broadcast in a similar manner per beam. However, for the serving cell, the gNB may choose to not constantly transmit system information (SI) and either transmit these in dedicated messages to the UEs when in connected mode or let the UEs ask for SI provision on demand. Depending on the gNB's configuration, the on-demand request from UE may either be done through random access specific resources or higher layer signaling. Regardless, UEs are informed via SIB1 that the current cell is broadcasting or can broadcast SI on-demand (see for example 3GPP TS 38.331 v 17.1.0, SchedulingInfo→si-BroadcastStatus→ENUMERATED{broadcasting, notBroadcasting}).

UEs are configured with the above SSB/SIB1/SI presence and timing/rate information either in RRC_IDLE/INACTIVE via broadcast system information or in RRC_Connected via dedicated RRC messages. In IDLE/INACTIVE, the ssb-PositionsInBurst and ssb-PeriodicityServing for serving cell is configured via SIB1 and the SMTC configurations for neighboring cells are provided in SIB2/SIB4 contained in SI messages.

For the sake of energy savings, there are discussions in a 3GPP Rel-18 study item on network (NW) energy efficiency about having cells that do not transmit SSBs or SIB1/SI. Instead, there is a coverage/overlapping cell that broadcasts SIB1/SI for the underlying cells and the UEs may acquire the information from the coverage cell instead.

### Master Information Block (MIB)

The MIB is transmitted the message part of the PBCH, which is a part of the SSB, and it contains the following information (see for example 3GPP TS 38.331 v 17.1.0):

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

In addition to the MIB content, the SSB also provide the UE with a physical cell identity (ID) (derived from the sequence indexes of the PSS and SSS) and an SSB-Index (derived from the sequence index of the demodulation reference signals (DM-RS) transmitted in the PBCH). As shown in FIG. 1, a normal SSB (as specified for example in NR Release 15) extends across 4 symbols in the time domain (in the horizontal direction in FIG. 1) and extends across 20 physical resource blocks (PRBs) in the frequency domain (in the vertical direction in FIG. 1). The PSS extends across 127 subcarriers (SC). Up to L SSBs may be transmitted in 5 ms. 20 ms SSB periodicity may be used for initial access.

### Challenges

There currently exist certain challenge(s). In the Rel 18 NW study item, the idea of a lightweight SSB or SSB-alike or Discovery Reference Signal (DRS) is mentioned as a replacement for the Rel-15 SSB so that the gNB can save power, e.g., by transmitting a lower number of symbols than a normal SSB.

One use case where DRS may be used is indicating a presence of a gNB that is temporarily inactivated. The UE may then, upon detecting the gNB, transmit a wake-up signal (WUS) to wake it up, for example to reactivate the gNB so that conventional SSBs are transmitted and the NR NW access procedure may be performed. For example, the patent application publication EP3313010A1 discloses that a wireless device detects a discontinuous transmission (DTX) cell that operates in a DTX state by receiving a discovery signal from the DTX cell, and transmits an initial request message to the DTX cell to request the DTX cell to transmission from the DTX state to a continuous transmission (TX) state.

In some scenarios, it may not be desirable that a WUS transmitted by a UE wakes up any gNB that can receive the WUS. Furthermore, it may be desirable to control for example the timing of the WUS transmission in relation to the DRS timing.

### SUMMARY

A first aspect provides embodiments of a method performed by a wireless communication device. The method comprises receiving a discovery signal and transmitting a wake-up signal (WUS) based on a WUS configuration. The WUS configuration is based on the discovery signal. The WUS configuration comprises a WUS permitted indicator or flag, and/or a number of WUS attempts to be made if a network node does not respond to the WUS, and/or a periodicity to be used for WUS attempts if a network node does not respond to the WUS, and/or a prohibition timer to be applied before making a second attempt to transmit the WUS if a network node does not respond to the WUS, and/or a response time/window during which to receive a response to the WUS.

Corresponding embodiments of a wireless communication device are also provided.

A second aspect provides embodiments of a method performed by a network node. The method comprises transmitting a discovery signal and receiving a wake-up signal (WUS) transmitted in accordance with a WUS configuration. The WUS configuration is based on the discovery signal. The WUS configuration comprises a WUS permitted indicator or flag, and/or a number of WUS attempts to be made if the network node does not respond to the WUS, and/or a periodicity to be used for WUS attempts if the network node does not respond to the WUS, and/or a prohibition timer to be applied before making a second attempt to transmit the WUS if the network node does not respond to the WUS, and/or a response time/window during which to receive a response to the WUS.

Corresponding embodiments of a network node are also provided.

### BRIEF DESCRIPTION OF THE DRAWINGS

The present disclosure may be best understood by way of example with reference to the following description and accompanying drawings that are used to illustrate embodiments of the present disclosure. In the drawings:

FIG. 1 shows an SSB extending across 4 symbols in the time domain and across 20 PRBs in the frequency domain;

FIG. 2 shows a flow chart of a method performed by a wireless communication device, according to some embodiments;

FIG. 3 shows a flow chart of a method performed by a network node, according to some embodiments;

FIG. 4 shows a high-level flow of at least some embodiments of a method performed by a UE;

FIG. 5 shows an example of a discovery reference signal (DRS);

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host in accordance with some embodiments;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

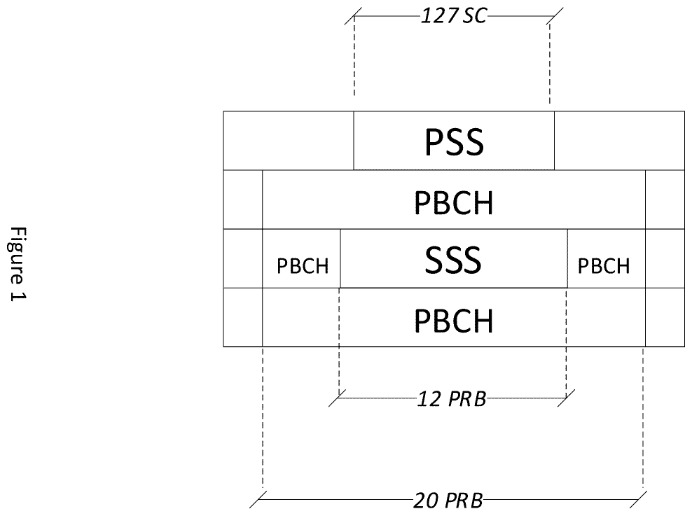

### DETAILED DESCRIPTION

Some of the embodiments contemplated herein will now be described more fully with reference to the accompanying drawings. Embodiments are provided by way of example to convey the scope of the subject matter to those skilled in the art.

In some scenarios, it may not be desirable that a WUS transmitted by a wireless communication device (such as a UE) wakes up any network node (such as gNB) that can receive the WUS. Furthermore, it may be desirable to control for example the timing of the WUS transmission in relation to the discovery signal (such as DRS) timing. There is thus a need for an approach to create an association between the DRS transmitted by a gNB and the WUS transmitted by the UE so that only the specific gNB is triggered to wake up and reactivate itself and that the WUS time/frequency (T/F) location can be controlled by the gNB.

Certain aspects of the disclosure and their embodiments may provide solutions to these or other challenges. A mapping between the discovery reference signal (DRS) and the wake-up signal (WUS) is defined so that the UE can select a WUS configuration expected by the given gNB based on the received DRS.

Two mapping approaches are considered:
1. A fixed mapping between the received DRS and the expected WUS configuration is used, e.g. a DRS transmission parameter index→WUS configuration index table is provided.
2. WUS configuration parameters are embedded in DRS info fields as one or more separate parameters or parameter indices.

The DRS transmission parameters may include a sequence index, raster position (T/F) index, format, etc.

The WUS configuration parameters may include sequence index (incl. root sequence+cyclic shift), T/F location relative to the DRS position, WUS response and retransmission parameters, etc.

The mapping info may be obtained e.g. from a spec document (for example a 3GPP TS document) or from a SIB (or other SI-related) transmission in the network, including from other nodes or at earlier time instants.

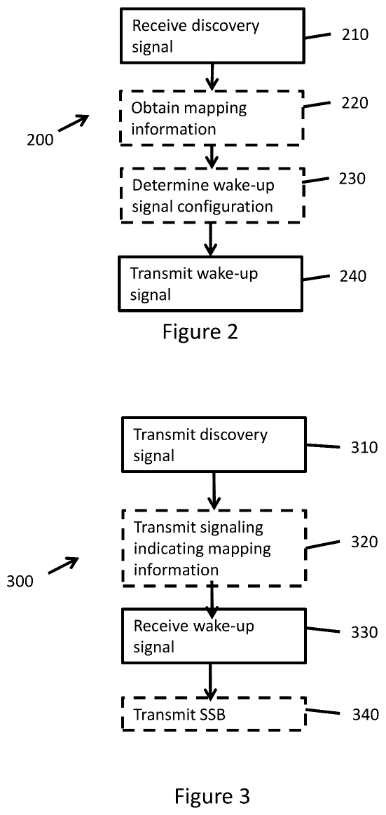

Embodiments of a method performed by a wireless communication device (for example a UE) will now be described. FIG. 2 illustrates an example flow chart of such a method 200.

According to some embodiments, the method 200 comprises receiving 210 a discovery signal; and transmitting 240 a wake-up signal based on a wake-up signal configuration, wherein the wake-up signal configuration is based on the discovery signal. The discovery signal may for example be the discovery reference signal (DRS) referred to throughout the present disclosure. The discovery signal may for example occupy less time and/or frequency resources than a synchronization signal bock (SSB) specified in NR Release 15.

According to some embodiments, the wake-up signal configuration is based on the discovery signal and mapping information. In such embodiments, the method 200 may for example further comprise obtaining 220 the mapping information.

According to some embodiments, the method 200 further comprises determining 230 the wake-up signal configuration based on the discovery signal and the mapping information.

Further embodiments of the method 200 are provided throughout the present disclosure, for example in the section entitled “Group A Embodiments”.

Embodiments of a method performed by a network node (for example a radio network node, such as a gNB) will now be described. FIG. 3 illustrates an example flow chart of such a method 300.

According to some embodiments, the method 300 comprises transmitting 310 a discovery signal; and receiving 330 a wake-up signal transmitted in accordance with a wake-up signal configuration, wherein the wake-up signal configuration is based on the discovery signal. The discovery signal may for example be the discovery reference signal (DRS) referred to throughout the present disclosure. The discovery signal may for example occupy less time and/or frequency resources than a synchronization signal bock (SSB) specified in NR Release 15.

According to some embodiments, the wake-up signal configuration is based on the discovery signal and mapping information. In such embodiments, the method 300 may for example further comprise transmitting 320 signaling indicating or comprising the mapping information.

According to some embodiments, the method 300 further comprises transmitting 340 signaling indicating receipt of the wake-up signal. The signaling may for example be an SSB.

Further embodiments of the method 300 are provided throughout the present disclosure, for example in the section entitled “Group B Embodiments”.

Some example embodiments are as follows.

Embodiment 1. A method in a UE for transmitting an indication requesting to activate an inactive gNB, comprising:
receiving a DRS comprising one or more DRS characteristics;
obtaining a DRS-to-WUS mapping info;
determining a WUS configuration based on the DRS characteristics and the mapping info;
transmitting a WUS based on the WUS configuration.

Embodiment 2. The method of Embodiment 1, wherein the WUS configuration comprises one or more of WUS parameters, e.g.:
WUS permitted,
WUS sequence/preamble index (which may further comprise a root sequence index+cyclic shift value),
WUS time offset (symbol, slot, ms, . . . ) relative to the DRS timing,
WUS frequency offset (REs, PRBs, . . . ) relative to the DRS position,
WUS T/F resources (e.g., it can be the same as DRS with some offsets),
WUS subcarrier spacing (SCS),
the number of WUS attempts if a gNB does not respond,
the periodicity of WUS attempts if the gNB does not respond,
the prohibition timer before a second attempt if the gNB does not respond,
the WUS transmission window length,
the WUS response time/window (maximum time during which the NW needs to send SSB or WUS-ACK).

Embodiment 3. The method of any of Embodiment 1-2, wherein the DRS characteristics comprise one or more DRS information fields, and wherein the mapping comprises determining one or more WUS parameters based on one or more DRS info fields (e.g. as tables or functions WUS_parameter_n=F_n(DRS_info_field_n)).

Embodiment 3a. The method of Embodiment 3, wherein the DRS information fields comprise one or more of:
a WUS sequence index,
a WUS time offset index,
a WUS frequency offset index,
etc. (see Embodiment 2 above for a more complete list).

Embodiment 3b. The method of Embodiment 3, wherein the received DRS format is a first format (larger, multiple symbols accommodating channel-encoded info fields).

Embodiment 3c. The method of Embodiment 3, wherein the information field can be embedded in a synch signal type DRS, e.g., a light weight SSB or SSB like signal with potentially lower number of symbols than a legacy SSB (such as a Rel 15 SSB), or as part of another signal transmitted along with DRS, e.g., a SI broadcast signal such as a lighter version of SIB1 or LW-SIB1.

Embodiment 4. The method of any of Embodiments 1-3c, wherein the DRS characteristics comprise DRS transmission parameters, wherein the mapping comprises determining one or more WUS parameters based on one or more DRS transmission parameters (e.g. as tables or functions WUS_parameter_m=F_m (DRS_trans_parameters_m)).

Embodiment 4a. The method of Embodiment 4, wherein the DRS transmission parameters comprise one or more of:
a sequence index of a sequence found in the DRS (e.g. PSS, SSS-like, etc.),
DRS raster position index (T/F location index in a predefined table),
DRS format (number of symbols, presence of information fields, . . . ), etc.

Embodiment 4b. The method of Embodiment 4, wherein the received DRS format is a second format (smaller, 1-2 symbols with sequence-encoding, no channel-encoded info fields)
Example 1: DRS root sequence index maps to WUS sequence index.
Example 2: DRS cyclic shift index maps to WUS T/F position offset in relation to DRS location.
Example 3: DRS frequency raster index modulo 4 maps to WUS position offset,
Example 4: Multiple concatenated DRS parameter indices map to a composite WUS configuration index (although maybe not very desirable since this reduces configuration flexibility).

Embodiment 5. The method of any of Embodiments 1-4b, wherein the obtaining comprises receiving mapping info from a SIB or other SI-related transmissions in the NW (e.g. SIB in other cells, or lightweight SIB in the deactivated cell/gNB).

Embodiment 6. The method of any of Embodiments 1-5, wherein the obtaining comprises using mapping rules in a specification document, stored on a Subscriber Identity Module (SIM) card, etc.

Certain embodiments may provide one or more of the following technical advantage(s). At least some embodiments disclosed herein allow the UE to transmit a WUS to wake up a specific gNB and perform the WUS transmission in accordance with a configuration/resource selected/indicated by the network (NW) even in the absence of any traditional system information (SI). Thus, inadvertent activation of unintended gNBs is avoided, maximizing energy efficiency in the NW. Also, creation of unintended interference in the NW due to the WUS transmission is avoided since the WUS configuration is controlled by the NW.

### Additional Explanation

At least some embodiments proposed herein solve the problem of waking up a particular inactivated cell without affecting other cells in the NW coverage area. Some embodiments provide the solution where the UE receives a DRS from the inactivated cell/gNB and determines the WUS configuration that targets the particular gNB based on the characteristics of the received DRS. This is different compared to approaches where the WUS configuration is obtained from other SI transmissions.

The WUS configuration parameters required by the UE to successfully wake up a gNB may for example include one or more of the following:
Procedure flag:
   WUS permitted (yes/no)
Physical/waveform parameters
   WUS sequence/preamble index (which may further comprise a root sequence index+cyclic shift value),
   WUS time offset (symbol, slot, ms, . . . ) relative to the DRS timing,
   WUS frequency offset (REs, PRBs, . . . ) relative to the DRS position,
   WUS T/F resources (absolute values or relative to band/carrier location, Universal time, etc.),
   WUS SCS,
WU procedure guidelines
   the number of WUS attempts if gNB does not respond,
   the periodicity of WUS attempts if the gNB does not respond,
   the prohibition timer before a second attempt if the gNB does not respond,
   the WUS transmission window length,
   the WUS response time/window (time or maximum time during which the NW needs for wakeup or acknowledge WUS)
   other WUS and response procedure parameters, etc.

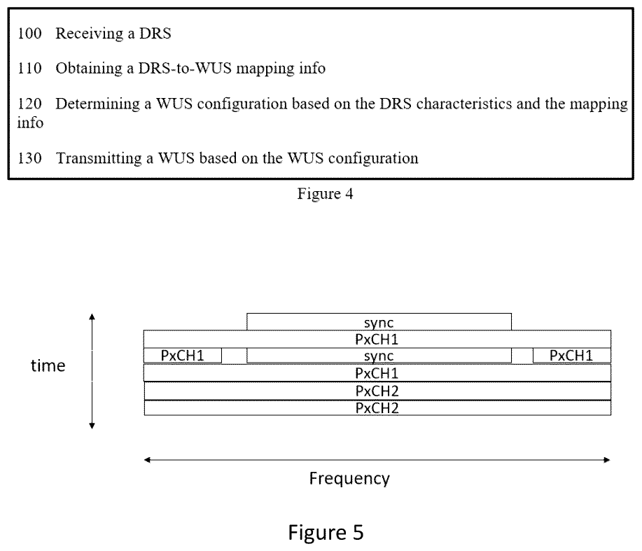

The high-level flow of at least some embodiments of a method performed by a UE may then be summarized as shown in FIG. 4.

Step 100 of FIG. 4: The UE receives a DRS transmitted by the gNB. The DRS may be transmitted in one of predetermined frequency raster locations and/or predetermined NW time or universal time slots.

The DRS structure may include sync signals amenable to detecting the presence of the signal and its exact time and frequency location; more details/options are listed below. The UE may search for the DRS using procedures similar to NR SSB PSS/SSS search.

Step 110 of FIG. 4: The UE obtains mapping info describing how to translate certain characteristics of the received DRS (e.g. its transmission properties or information fields it contains) to relevant WUS configuration parameters. The mapping info may be expressed as tables, functions, etc.

In one embodiment, the mapping info is provided via NW signaling e.g. in a broadcasted SIB or SIB-like entity, in dedicated RRC transmission, or another SI-related transmission. The mapping information may be provided by another cell in the NW, by the inactivated cell via a special lightweight SI transmission, or by a cell in the NW at an earlier point in time. In another embodiment, it is provided in the form of one or more fixed relations, e.g. in a specification document or on the SIM card.

Step 120 of FIG. 4: In this step, the UE performs mapping of DRS characteristics to WUS parameters. At least two types of DRS characteristics may be utilized.

In one class of embodiments, the DRS characteristics of interest are one or more DRS information fields that can carry explicit WUS configuration info or indices that can be converted to parameter values based on the mapping info. The mapping step thus comprises determining one or more WUS parameters based on one or more DRS info fields. The info fields may contain one or more of the above listed WUS configuration parameters. The mapping relations may be expressed e.g. as tables or functions where, for the n-th parameter,

$$WUS\_parameter \_n = F\_n ( DRS\_info \_field \_n )$$

In such embodiments, the received DRS format may be a first format, with relatively larger size, containing multiple symbols that accommodate transport channels with channel-encoded info fields. In one variant, the information field(s) can be embedded in a synch signal type DRS, e.g., a light weight SSB or SSB-like signal with same or lower number of symbols than a legacy SSB, e.g., a Rel 15 SSB.

In another class of embodiments, the DRS characteristics of interest are one or more DRS transmission parameters that may include:
A sequence index of a sequence found in the DRS: The sequence may be e.g. PSS, SSS, or similar sequence out of a predetermined list of sequences where each sequence has an associated index.
DRS raster position index: Index of the frequency (F) location (or T/F location if NW time or universal time is assumed to be available) in a predefined search raster table.
DRS format: distinguished by e.g. the number of symbols used, presence of information fields, etc.

The mapping step then comprises determining one or more WUS parameters based on one or more DRS transmission parameters. The mapping relations may be expressed e.g. as tables or functions where, for the m-th parameter,

$$WUS\_parameter \_m = F\_m ( DRS\_trans \_parameters \_m )$$

In such embodiments, the received DRS format may be a second format, relatively smaller in size, e.g. 1-2 symbols, containing sequence-encoding but not necessarily channel-encoded info fields.

Some examples of this class of embodiments include:
1. DRS-PSS or DRS-SSS root sequence index maps to WUS sequence index
2. DRS-PSS or DRS-SSS cyclic shift index maps to WUS T/F position offset in relation to DRS location
3. DRS frequency raster index modulo 4 maps to WUS position offset, . . . .
4. Multiple concatenated DRS parameter indices map to a composite WUS configuration index
5. A predetermined DRS-PSS/SSS sequence may indicate that the gNB is not WUS-wakeable.

Step 130 of FIG. 4: The UE transmits a WUS according to the WUS configuration determined in step 120. WUS parameters relating to the physical signal are used to generate the transmitted waveform. WUS parameters related to the wake-up (WU) procedure are used to control the reception of the response form the gNB and assessing the success of the WU, possible re-transmission of the WUS, etc.

In one embodiment, if the WUS parameters include a WU-permitted flag and the flag is negative, no WUS transmission is performed.

In one embodiment, if the gNB does not respond, the UE may assume that the gNB does not wake up and is not available for communication.

### Examples of DRS Physical Structure Compared to Rel-15 SSB

In one aspect, the T/F/spatial resources of DRS is difference from a normal SSB, e.g., one or more of the beams associated with DRS can be different from the normal SSB, e.g., a DRS can have a different periodicity than an SSB, a DRS can be packed in time resources while SSB signals cannot be packed in a row in time and only 2 SSBs are allowed per slot, the DRS is transmitted in different T/F resources compared to the SSB raster. DRS can be also configured in a duty cycle based, e.g., every 640 ms, a specific number of DRSs, e.g, 5 DRSs are transmitted with a periodicity of 20 ms. Other examples are not excluded.

In one aspect, the PSS or SSS are modified, where the modification may comprise, a different sequence compared to Rel-15, a lower number of REs/PRBs utilized, etc. E.g., the UE receives a modified version of PSS and recognizes that this is a DRS and not an SSB.

In one aspect, the DRS only occupies one symbol, e.g., only a PSS or a modified version of Rel-15 PSS; or only an SSS and/or a modified SSS, or a combination of options, e.g., a PSS and a SSS or a modified version in a frequency-multiplexed configuration.

In one aspect, the UE recognizes the modified SSB based on not detecting a corresponding Rel-15 SSS or PSS, respectively, or based on not decoding a corresponding PBCH. E.g., when DRSs are configured where SSBs otherwise would have been configured, e.g., DRS overlaps with a PSS in T/F resources.

In one aspect, the DRS occupies at least two symbols where in one example PSS and SSS or modified versions of them are located in different symbols compared to legacy PSS/SSS symbols. The UE may perform tentative reception with legacy and DRS symbol assumptions to determine whether the received signal is a DRS.

In one aspect, the MIB (or the new version of it) is located around SSS or its modified version, e.g., the UE is configured with a PSS and a SSS as reference signals (RSS) in DRS, and PSS is in the first symbol while SSS in the second one and then MIB is configured around SSS. In one aspect the UE is configured with a MIB around the PSS or both PSS and SSS or modified versions of them.

In one aspect, the UE is configured with a 3 symbol DRS or normal SSB size-1 symbol and MIB occupies at least one symbol of its own.

In one aspect, the DRS includes a Master Information Block MIB which is a lightweight version of the NR PBCH/MIB (normal MIB), where the number of PBCH symbols or resource elements (Res) is reduced and/or one or more components of the normal MIB is not present. Such reduction can for example be achieved by shorter payload field, different coding scheme, different cyclic redundancy check (CRC) length, different demodulation reference signal (DMRS) configuration, etc.

### Modifications to Information Contents

Furthermore, for a MIB in the DRS, the new MIB contents may comprise one or more changes compared to Rel-15 MIB (normal MIB), such as:
Omitting one or more of the currently defined parameters {cellBarred, intraFreqReselection, pdcch-ConfigSIB1, . . . }, or currently provided beam index
adding one or more of
   Wakeup Signal (WUS) configuration, or a configuration index. Rather than having a generic WUS that wakes up every gNB that receives/decodes a WUS, instead, there exist a bank (several configurations) of distinguishable WUSs. Each WUS is tied to a DRS. When a UE decodes a DRS and wants to wake up the gNB it transmits a relevant WUS (out of several) that wakes up that specific gNB. This configuration may in one embodiment be optionally provided by the NW. In one embodiment, if the information is not present, then waking up of this gNB is not allowed.

For obtaining/determining the uplink wakeup signal configuration, the UE may acquire mapping info from a physical layer signal/channel (such as a lightweight SSB, DRS or a PBCH), or a higher layer signaling such as system information block. The mapping information may then be employed to determine the WUS configuration based on the DRS (or based on characteristics/properties of the DRS).

One example DRS is shown in FIG. 5. This shows a DRS comprising a sync signal occupying one or two symbols (e.g. sync in first symbol may be a PSS, sync in other symbol may be a SSS, etc.), and up to four symbols of a first channel (PxCH1) (which may be a primary broadcast channel), and up to two symbols of a second channel (PxCH2) (which may be a second broadcast channel). In another example, the ordering of the different symbols in time domain may be different (e.g., a first symbol of PxCH2 may appear before the first sync symbol, etc.), and/or the number of symbols for sync, PxCH1, PxCH2 may be different.

In an example, the DRS transmission may omit PxCH1 and only transmit sync and PxCH2.

In an example, the DRS transmission may omit PxCH2 and only transmit sync and PxCH1.

In an example, the DRS transmission may in some instances (e.g., in time domain) omit PxCH2 and only transmit sync and PxCH1, and in some instances omit PxCH1 and only transmit sync and PxCH2.

In an example, the periodicity of signals/channels in the DRS transmission may be different (e.g., in time domain), for example, PxCH2 may be transmitted with a first periodicity (e.g., 40/80 ms) and sync/PxCH1 may be transmitted with a second periodicity (e.g., 20 ms).

In an example, the PxCH2 may be considered as a separate broadcast channel that may be separate from DRS (e.g. in which case DRS comprises only sync and PxCH1 and DRS contains information to acquire PxCH2).

In an example, the PxCH2 may be considered as a separate broadcast channel that may be separate from DRS (e.g. in which case DRS comprises only sync and PxCH1 and DRS contains information to acquire PxCH2 including at least one bit to indicate one or more of the following: whether the PxCH2 is present/absent, PxCH2 location relative to sync/PxCH1, etc.).

In an example, the PxCH1 (or PxCH2) may carry a first payload and first set of contents in a first instance (e.g. in time domain) and it may carry a second payload and a second set of contents in a second instance (e.g. in time domain). For example, these could be MIB type 1 (e.g. legacy Rel-15 MIB) and MIB type 2 (with at least one field that is distinct from fields in MIB type 1).

Each of the information associated with uplink wakeup signal (such as DRS-to-WUS mapping information, WUS configuration, etc.) may be carried in at least one of PxCH1 and or PxCH2 as part of the first payload or second payload in a first or a second instance.

The UE may attempt to decode one or more instances of DRS to acquire synchronization and obtain uplink wakeup signal information and transmit a WUS according to the obtained information.

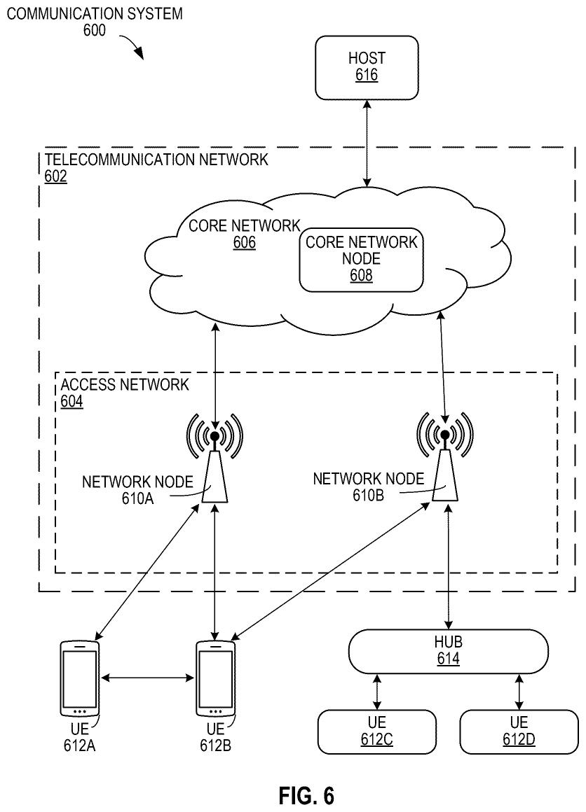

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

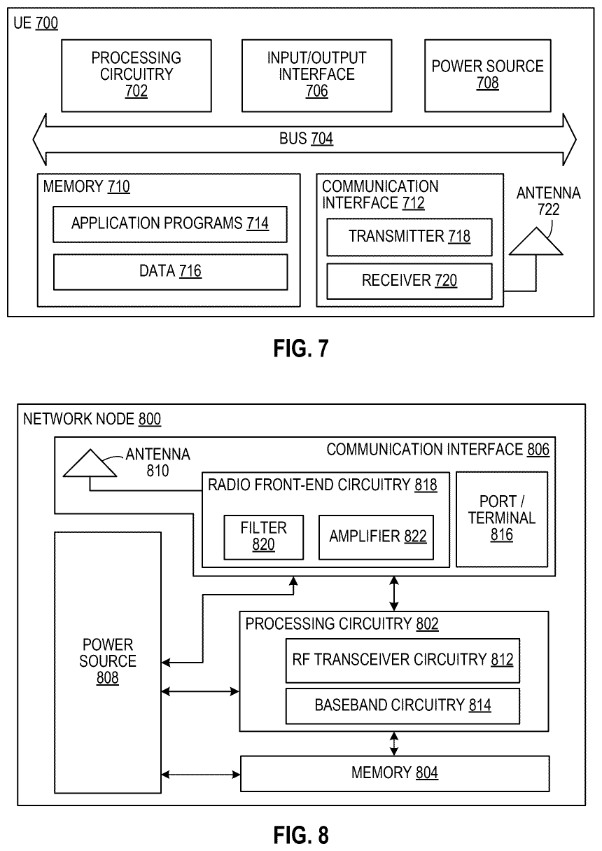

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE. The “term wireless communication device” is also used in some places of this disclosure to denote devices such as UEs.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

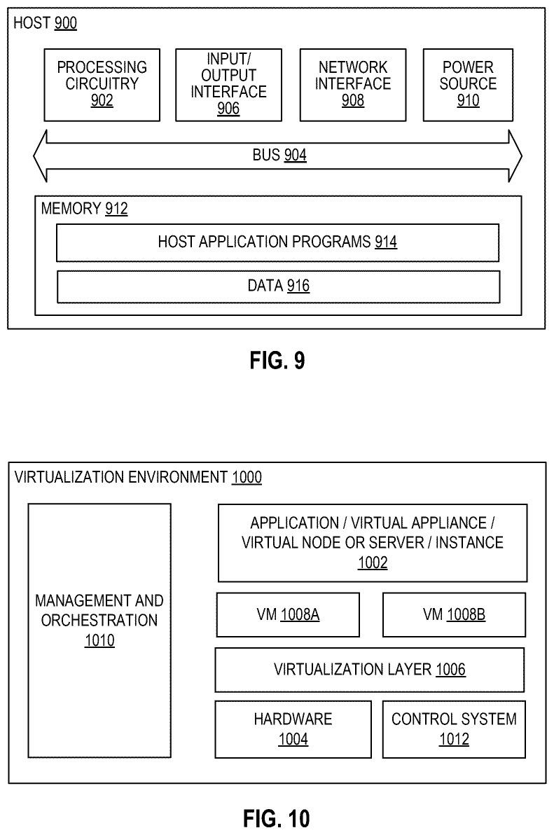

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

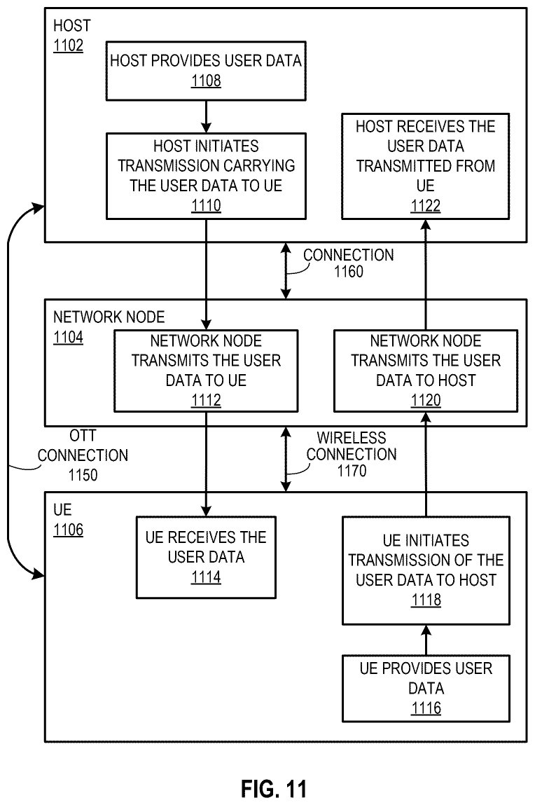

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may reduce the power consumption of network nodes 1104, and thereby provide benefits such as reduced power consumption of the overall communication system.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method (200) performed by a wireless communication device, the method comprising:
   receiving (210) a discovery signal; and
   transmitting (240) a wake-up signal based on a wake-up signal configuration, wherein the wake-up signal configuration is based on the discovery signal.
2. The method of any of the preceding group A embodiments, wherein the wake-up signal configuration is based on the discovery signal and mapping information.
3. The method of the preceding embodiment, wherein the mapping information indicates how one or more characteristics/properties of the discovery signal are to be mapped to one or more characteristics/properties of the wake-up signal configuration.
4. The method of any of the two preceding embodiments, wherein the mapping information is indicative of a table or function for converting one or more characteristics/properties of the discovery signal into one or more characteristics/properties of the wake-up signal configuration.
5. The method of any of the three preceding embodiments, further comprising:
   obtaining (220) the mapping information.
6. The method of the preceding embodiment, wherein the mapping information is obtained via signaling from a network node.
7. The method of the preceding embodiment, wherein said signaling includes:
   a broadcasted system information block, SIB; and/or
   dedicated radio resource control, RRC, signaling.
8. The method of any of the three preceding embodiments, wherein the mapping information is obtained via signaling from a first cell and/or network node, and wherein the wake-up signal is transmitted to a second cell and/or network node different from the first cell and/or network node.
9. The method of any of the seven preceding embodiments, further comprising:
   determining (230) the wake-up signal configuration based on the discovery signal and the mapping information.
10. The method of any of the preceding group A embodiments, wherein the discovery signal comprises one or more information fields carrying explicit information about the wake-up signal configuration.
11. The method of any of the nine preceding embodiments, wherein the discovery signal comprises one or more information fields carrying one or more indices, and wherein the mapping information indicates how the one or more indices are convertible into one or more parameter values of the wake-up signal configuration.
12. The method of any of the ten preceding embodiments, wherein the mapping information indicates how one or more characteristics of the discovery signal (for example a sequence index, a raster position index, and/or a format of the discovery signal) are convertible into one or more parameter values of the wake-up signal configuration.
13. The method of any of the preceding group A embodiments, further comprising:
   receiving signaling indicating receipt of the wake-up signal by a network node.
14. The method of the preceding embodiment, wherein the signaling is received in a time and/or frequency resource determined based on the discovery signal.
15. The method of the preceding embodiment, further comprising:
   determining the time and/or frequency resource based on the discovery signal (for example based on one or more characteristics or properties of the discovery signal).
16. The method of any of the preceding group A embodiments, wherein the wake-up signal is transmitted responsive to a value of a flag in the discovery signal (for example responsive to a “wake-up signal permitted” flag in the discovery signal being set to true).
17. The method of any of the preceding group A embodiments, wherein the discovery signal comprises one or two channels.
18. The method of the preceding embodiment, wherein at least one of the one or two channels is a broadcast channel.
19. The method of any of the preceding group A embodiments, wherein the discovery signal comprises one or two synchronization signals.
20. The method of any of the preceding group A embodiments, wherein the wake-up signal is transmitted for requesting a network node in a power saving mode (which may for example be referred to as an inactive mode) to be activated.
21. The method of any of the preceding group A embodiments, wherein the wake-up signal (WUS) configuration comprises one or more of wake-up signal parameters, such as for example one or more of:
   a WUS permitted indicator/flag;
   a WUS sequence/preamble index (which may further comprise a root sequence index and/or a cyclic shift value);
   a WUS time offset (symbol, slot, ms, . . . ) relative to the discovery signal timing;
   WUS frequency offset (REs, PRBs, . . . ) relative to the discovery signal position;
   WUS T/F resources (e.g., it can be the same as for the discovery signal but with some offset);
   WUS subcarrier spacing (SCS);
   the number of WUS attempts if a network node does not respond to the WUS,
   the periodicity of WUS attempts if the network node does not respond to the WUS,
   a prohibition timer before a second attempt if the network node does not respond to the WUS,
   a WUS transmission window length;
   a WUS response time/window (maximum time during which the NW needs to send SSB or WUS-ACK).
22. The method of any of the preceding group A embodiments, wherein the wake-up signal configuration is based on one or more parameters associated with the discovery signal, such as for example one or more of:
   a sequence index of a sequence found in the discovery signal (for example PSS, SS, PSS-like, SSS-like, etc.);
   discovery signal raster position index (for example T/F location index in a predefined table);
   discovery signal format (for example number of symbols and/or presence of information fields).
23. The method of any of the preceding group A embodiments, wherein the discovery signal has a format with sequence-encoding (and for example no channel-encoded information fields).
24. The method of any of the preceding group A embodiments, wherein the wake-up signal configuration is selected, based on the discovery signal, from a collection of wake-up signal configurations.
25. The method of the preceding embodiment, wherein the wake-up signal configurations in said collection are associated with different cells.
26. The method of any of the preceding group A embodiments, wherein the discovery signal occupies less time and/or frequency resources than a synchronization signal bock, SSB, specified in NR Release 15.
27. The method of any of the preceding group A embodiments, wherein the discovery signal occupies less than four symbols in a time domain.
28. The method of any of the preceding group A embodiments, wherein the discovery signal occupies less than four orthogonal frequency-division multiplexing, OFDM, symbols.
29. The method of any of the preceding group A embodiments, wherein the discovery signal occupies less than 20 physical resource blocks, PRBs, in a frequency domain.
30. The method of any of the preceding group A embodiments, wherein the discovery signal comprises:
   a primary synchronization signal; and/or
   a secondary synchronization signal; and/or
   a physical broadcast channel; and/or
   a master information block.
31. The method of any of the preceding group A embodiments, wherein the discovery signal comprises a primary synchronization signal that:
   occupies less time and/or frequency resources than a primary synchronization signal,
   PSS, specified in NR Release 15; and/or
   is based on a different sequence than a primary synchronization signal, PSS, specified in NR Release 15; and/or
   is located at different time and/or frequency resources than a primary synchronization signal, PSS, specified in NR Release 15.
32. The method of any of the preceding group A embodiments, wherein the discovery signal comprises a secondary synchronization signal that:
   occupies less time and/or frequency resources than a secondary synchronization signal, SSS, specified in NR Release 15; and/or
   is based on a different sequence than a secondary synchronization signal, SSS, specified in NR Release 15; and/or
   is located at different time and/or frequency resources than a secondary synchronization signal, SSS, specified in NR Release 15.
33. The method of any of the preceding group A embodiments, wherein the discovery signal comprises a master information block that:
   occupies less time and/or frequency resources than a master information block, MIB, specified in NR Release 15; and/or
   is located at different time and/or frequency resources than a master information block, MIB, specified in NR Release 15; and/or
   lacks at least one part/portion/field/parameter of a master information block, MIB, specified in NR Release 15; and/or
   has a modified version of at least one part/portion/field/parameter of a master information block, MIB, specified in NR Release 15.
34. The method of any of the preceding group A embodiments, wherein the discovery signal comprises a physical broadcast channel that:
   occupies less time and/or frequency resources than a physical broadcast channel, PBCH, specified in NR Release 15; and/or
   is located at different time and/or frequency resources than a physical broadcast channel, PBCH, specified in NR Release 15; and/or
   uses a different coding scheme, a different cyclic redundancy check length, a different demodulation reference signal configuration than a physical broadcast channel, PBCH, specified in NR Release 15.
35. The method of any of the preceding group A embodiments, wherein the discovery signal is provided in a different beam and/or with a different periodicity than a synchronization signal bock, SSB, specified in NR Release 15.
36. The method of any of the preceding group A embodiments, further comprising:
   providing user data; and
   forwarding the user data to a host via the transmission to the network node.

### Group B Embodiments

1. A method (300) performed by a network node, the method comprising:
   transmitting (310) a discovery signal; and
   receiving (330) a wake-up signal transmitted in accordance with a wake-up signal configuration, wherein the wake-up signal configuration is based on the discovery signal.
2. The method of any of the preceding group B embodiments, wherein the wake-up signal configuration is based on the discovery signal and mapping information.
3. The method of the preceding embodiment, wherein the mapping information indicates how one or more characteristics/properties of the discovery signal are to be mapped to one or more characteristics/properties of the wake-up signal configuration.
4. The method of any of the two preceding embodiments, wherein the mapping information is indicative of a table or function for converting one or more characteristics/properties of the discovery signal into one or more characteristics/properties of the wake-up signal configuration.
5. The method of any of the three preceding embodiments, further comprising: transmitting (320) signaling indicating or comprising the mapping information.
6. The method of the preceding embodiment, wherein said signaling includes:
   a broadcasted system information block, SIB; and/or
   dedicated radio resource control, RRC, signaling.
7. The method of any of the preceding group B embodiments, wherein the discovery signal comprises one or more information fields carrying explicit information about the wake-up signal configuration.
8. The method of any of the six preceding embodiments, wherein the discovery signal comprises one or more information fields carrying one or more indices, and wherein the mapping information indicates how the one or more indices are convertible into one or more parameter values of the wake-up signal configuration.
9. The method of any of the seven preceding embodiments, wherein the mapping information indicates how one or more characteristics of the discovery signal (for example a sequence index, a raster position index, and/or a format of the discovery signal) are convertible into one or more parameter values of the wake-up signal configuration.
10. The method of any of the preceding group B embodiments, further comprising:
   transmitting (340) signaling indicating receipt of the wake-up signal.
11. The method of the preceding embodiment, wherein the signaling is transmitted in a time and/or frequency resource indicated by the discovery signal.
12. The method of any of the preceding group B embodiments, wherein the discovery signal comprises a flag (for example a “wake-up signal permitted” flag) indicating that the network node (or a cell operated by the network node) can be activated by a wake-up signal.
13. The method of any of the preceding group B embodiments, wherein the discovery signal comprises one or two channels.
14. The method of the preceding embodiment, wherein at least one of the one or two channels is a broadcast channel.
15. The method of any of the preceding group B embodiments, wherein the discovery signal comprises one or two synchronization signals.
16. The method of any of the preceding group B embodiments, wherein the discovery signal is transmitted and the wake-up signal is received while the network node is in a power saving mode (which may for example be referred to as an inactive mode), and wherein the method further comprises:
   exiting the power saving mode in response to receiving the wake-up signal.
17. The method of any of the preceding group B embodiments, wherein the wake-up signal (WUS) configuration comprises one or more of wake-up signal parameters, such as for example one or more of:
   a WUS permitted indicator/flag;
   a WUS sequence/preamble index (which may further comprise a root sequence index and/or a cyclic shift value);
   a WUS time offset (symbol, slot, ms, . . . ) relative to the discovery signal timing;
   WUS frequency offset (REs, PRBs, . . . ) relative to the discovery signal position;
   WUS T/F resources (e.g., it can be the same as for the discovery signal but with some offset);
   WUS subcarrier spacing (SCS);
   the number of WUS attempts if a network node does not respond to the WUS,
   the periodicity of WUS attempts if the network node does not respond to the WUS,
   a prohibition timer before a second attempt if the network node does not respond to the WUS,
   a WUS transmission window length;
   a WUS response time/window (maximum time during which the NW needs to send SSB or WUS-ACK).
18. The method of any of the preceding group B embodiments, wherein the wake-up signal configuration is based on one or more parameters associated with the discovery signal, such as for example one or more of:
   a sequence index of a sequence found in the discovery signal (for example PSS, SS, PSS-like, SSS-like, etc.);
   discovery signal raster position index (for example T/F location index in a predefined table);
   discovery signal format (for example number of symbols and/or presence of information fields).
19. The method of any of the preceding group B embodiments, wherein the discovery signal has a format with sequence-encoding (and for example no channel-encoded information fields).
20. The method of any of the preceding group B embodiments, wherein the wake-up signal configuration is selected, based on the discovery signal, from a collection of wake-up signal configurations.
21. The method of the preceding embodiment, wherein the wake-up signal configurations in said collection are associated with different cells.
22. The method of any of the preceding group B embodiments, wherein the discovery signal occupies less time and/or frequency resources than a synchronization signal bock, SSB, specified in NR Release 15.
23. The method of any of the preceding group B embodiments, wherein the discovery signal occupies less than four symbols in a time domain.
24. The method of any of the preceding group B embodiments, wherein the discovery signal occupies less than four orthogonal frequency-division multiplexing, OFDM, symbols.
25. The method of any of the preceding group B embodiments, wherein the discovery signal occupies less than 20 physical resource blocks, PRBs, in a frequency domain.
26. The method of any of the preceding group B embodiments, wherein the discovery signal comprises:
   a primary synchronization signal; and/or
   a secondary synchronization signal; and/or
   a physical broadcast channel; and/or
   a master information block.
27. The method of any of the preceding group B embodiments, wherein the discovery signal comprises a primary synchronization signal that:
   occupies less time and/or frequency resources than a primary synchronization signal, PSS, specified in NR Release 15; and/or
   is based on a different sequence than a primary synchronization signal, PSS, specified in NR Release 15; and/or
   is located at different time and/or frequency resources than a primary synchronization signal, PSS, specified in NR Release 15.
28. The method of any of the preceding group B embodiments, wherein the discovery signal comprises a secondary synchronization signal that:
   occupies less time and/or frequency resources than a secondary synchronization signal, SSS, specified in NR Release 15; and/or
   is based on a different sequence than a secondary synchronization signal, SSS, specified in NR Release 15; and/or
   is located at different time and/or frequency resources than a secondary synchronization signal, SSS, specified in NR Release 15.
29. The method of any of the preceding group B embodiments, wherein the discovery signal comprises a master information block that:
   occupies less time and/or frequency resources than a master information block, MIB, specified in NR Release 15; and/or
   is located at different time and/or frequency resources than a master information block, MIB, specified in NR Release 15; and/or
   lacks at least one part/portion/field/parameter of a master information block, MIB, specified in NR Release 15; and/or
   has a modified version of at least one part/portion/field/parameter of a master information block, MIB, specified in NR Release 15.
30. The method of any of the preceding group B embodiments, wherein the discovery signal comprises a physical broadcast channel that:
   occupies less time and/or frequency resources than a physical broadcast channel, PBCH, specified in NR Release 15; and/or
   is located at different time and/or frequency resources than a physical broadcast channel, PBCH, specified in NR Release 15; and/or
   uses a different coding scheme, a different cyclic redundancy check length, a different demodulation reference signal configuration than a physical broadcast channel, PBCH, specified in NR Release 15.
31. The method of any of the preceding group B embodiments, wherein the discovery signal is provided in a different beam and/or with a different periodicity than a synchronization signal bock, SSB, specified in NR Release 15.
32. The method of any of the preceding group B embodiments, further comprising:
   obtaining user data; and
   forwarding the user data to a host or a user equipment or a wireless communication device.

### Group C Embodiments

1. A user equipment (UE) or wireless communication device configured to perform the method of any of the Group A embodiments.
2. A network node configured to perform the method of any of the Group B embodiments.
3-6.—
7. A user equipment or wireless communication device comprising:
   processing circuitry configured to perform any of the steps of any of the Group A embodiments; and
   power supply circuitry configured to supply power to the processing circuitry.
8. A network node comprising:
   processing circuitry configured to perform any of the steps of any of the Group B embodiments;
   power supply circuitry configured to supply power to the processing circuitry.
9. A user equipment (UE) or wireless communication device comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE or wireless communication device to be processed by the processing circuitry;
   an output interface connected to the processing circuitry and configured to output information from the UE or wireless communication device that has been processed by the processing circuitry; and
   a battery connected to the processing circuitry and configured to supply power to the UE or wireless communication device.
10. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE) or wireless communication device, the network node having a communication interface and processing circuitry, the processing circuitry of the network node configured to perform any of the operations of any of the Group B embodiments to transmit the user data from the host to the UE or wireless communication device.
11. The host of the previous embodiment, wherein:
   the processing circuitry of the host is configured to execute a host application that provides the user data; and
   the UE or wireless communication device comprises processing circuitry configured to execute a client application associated with the host application to receive the transmission of user data from the host.
12. A method implemented in a host configured to operate in a communication system that further includes a network node and a user equipment (UE) or wireless communication device, the method comprising:
   providing user data for the UE or wireless communication device; and
   initiating a transmission carrying the user data to the UE or wireless communication device via a cellular network comprising the network node, wherein the network node performs any of the operations of any of the Group B embodiments to transmit the user data from the host to the UE or wireless communication device.
13. The method of the previous embodiment, further comprising, at the network node, transmitting the user data provided by the host for the UE or wireless communication device.
14. The method of any of the previous 2 embodiments, wherein the user data is provided at the host by executing a host application that interacts with a client application executing on the UE or wireless communication device, the client application being associated with the host application.
15. A communication system configured to provide an over-the-top (OTT) service, the communication system comprising:
   a host comprising:
   processing circuitry configured to provide user data for a user equipment (UE) or wireless communication device, the user data being associated with the over-the-top service; and
   a network interface configured to initiate transmission of the user data toward a cellular network node for transmission to the UE or wireless communication device, the network node having a communication interface and processing circuitry, the processing circuitry of the network node configured to perform any of the operations of any of the Group B embodiments to transmit the user data from the host to the UE or wireless communication device.
16. The communication system of the previous embodiment, further comprising:
   the network node; and/or
   the UE or wireless communication device.
17. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) or wireless communication device for the host.
18. The host of the previous 2 embodiments, wherein:
   the processing circuitry of the host is configured to execute a host application that receives the user data; and
   the host application is configured to interact with a client application executing on the UE or wireless communication device, the client application being associated with the host application.
19. The host of the any of the previous 2 embodiments, wherein the initiating receipt of the user data comprises requesting the user data.
20. A method implemented by a host configured to operate in a communication system that further includes a network node and a user equipment (UE) or wireless communication device, the method comprising:
   at the host, initiating receipt of user data from the UE or wireless communication device, the user data originating from a transmission which the network node has received from the UE or wireless communication device, wherein the network node performs any of the steps of any of the Group B embodiments to receive the user data from the UE or wireless communication device for the host.
21. The method of the previous embodiment, further comprising at the network node, transmitting the received user data to the host.
22. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE) or wireless communication device, wherein the UE or wireless communication device comprises a communication interface and processing circuitry, the communication interface and processing circuitry of the UE or wireless communication device being configured to perform any of the operations of any of the Group A embodiments to receive the user data from the host.
23. The host of the previous embodiment, wherein the cellular network further includes a network node configured to communicate with the UE or wireless communication device to transmit the user data to the UE or wireless communication device from the host.
24. The host of the previous 2 embodiments, wherein:
   the processing circuitry of the host is configured to execute a host application, thereby providing the user data; and
   the host application is configured to interact with a client application executing on the UE or wireless communication device, the client application being associated with the host application.
25. A method implemented by a host operating in a communication system that further includes a network node and a user equipment (UE) or wireless communication device, the method comprising:
   providing user data for the UE or wireless communication device; and
   initiating a transmission carrying the user data to the UE or wireless communication device via a cellular network comprising the network node, wherein the UE or wireless communication device performs any of the operations of any of the Group A embodiments to receive the user data from the host.
26. The method of the previous embodiment, further comprising:
   at the host, executing a host application associated with a client application executing on the UE or wireless communication device to receive the user data from the host application.
27. The method of the previous embodiment, further comprising:
   at the host, transmitting input data to the client application executing on the UE or wireless communication device, the input data being provided by executing the host application,
   wherein the user data is provided by the client application in response to the input data from the host application.
28. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE) or wireless communication device, wherein the UE or wireless communication device comprises a communication interface and processing circuitry, the communication interface and processing circuitry of the UE or wireless communication device being configured to perform any of the steps of any of the Group A embodiments to transmit the user data to the host.
29. The host of the previous embodiment, wherein the cellular network further includes a network node configured to communicate with the UE or wireless communication device to transmit the user data from the UE or wireless communication device to the host.
30. The host of the previous 2 embodiments, wherein:
   the processing circuitry of the host is configured to execute a host application, thereby providing the user data; and
   the host application is configured to interact with a client application executing on the UE, the client application being associated with the host application.
31. A method implemented by a host configured to operate in a communication system that further includes a network node and a user equipment (UE) or wireless communication device, the method comprising:
   at the host, receiving user data transmitted to the host via the network node by the UE or wireless communication device, wherein the UE or wireless communication device performs any of the steps of any of the Group A embodiments to transmit the user data to the host.
32. The method of the previous embodiment, further comprising:
   at the host, executing a host application associated with a client application executing on the UE or wireless communication device to receive the user data from the UE or wireless communication device.
33. The method of the previous 2 embodiments, further comprising:
   at the host, transmitting input data to the client application executing on the UE or wireless communication device, the input data being provided by executing the host application,
   wherein the user data is provided by the client application in response to the input data from the host application.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 1x RTT | CDMA2000 1x Radio Transmission Technology |
| 3GPP | 3rd Generation Partnership Project |
| 5G | 5th Generation |
| 6G | 6^{th} Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip divided by the |
| | power density in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast service Single |
| | Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

1.-47. (canceled)

48. A method performed by a wireless communication device, the method comprising:
receiving a discovery signal; and
transmitting a wake-up signal, WUS, based on a WUS configuration, wherein the WUS configuration is based on the discovery signal, wherein the WUS configuration comprises one or more of:
a WUS permitted indicator or flag;
a number of WUS attempts to be made if a network node does not respond to the WUS;
a periodicity to be used for WUS attempts if a network node does not respond to the WUS;
a prohibition timer to be applied before making a second attempt to transmit the WUS if a network node does not respond to the WUS;
a response time/window during which to receive a response to the WUS.

49. The method of claim 48, wherein the WUS is transmitted responsive to a WUS permitted indicator or flag in the discovery signal.

50. The method of claim 48, further comprising:
receiving signaling indicating receipt of the WUS by a network node, wherein the signaling is received in a time and/or frequency resource determined based on the discovery signal.

51. The method of claim 48, wherein the wake-up signal configuration is based on the discovery signal and mapping information,
wherein the mapping information indicates how one or more characteristics/properties of the discovery signal are to be mapped to one or more characteristics/properties of the WUS configuration, or
wherein the mapping information is indicative of a table or function for converting one or more characteristics/properties of the discovery signal into one or more characteristics/properties of the WUS configuration.

52. The method of claim 48, wherein the WUS configuration is based on the discovery signal and mapping information, wherein the discovery signal comprises one or more information fields carrying one or more indices, and wherein the mapping information indicates how the one or more indices are convertible into one or more parameter values of the WUS configuration.

53. The method of claim 51, further comprising:
obtaining the mapping information.

54. The method of claim 53, wherein the mapping information is obtained via signaling from a network node.

55. The method of claim 54, wherein said signaling includes:
a broadcasted system information block, SIB; and/or
dedicated radio resource control, RRC, signaling.

56. The method of claim 53, wherein the mapping information is obtained via signaling from a first cell and/or network node, and wherein the WUS is transmitted to a second cell and/or network node different from the first cell and/or network node.

57. The method of claim 48, wherein the discovery signal comprises one or more information fields carrying explicit information about the WUS configuration.

58. The method of claim 48, wherein the discovery signal comprises one or two channels, wherein at least one of the one or two channels is a broadcast channel.

59. The method of claim 48, wherein the discovery signal comprises one or two synchronization signals.

60. The method of claim 48, wherein the WUS is transmitted for requesting a network node in a power saving mode to be activated.

61. The method of claim 48, wherein the WUS configuration further comprises one or more of:
a WUS sequence/preamble index;
a WUS time offset relative to the discovery signal timing;
WUS frequency offset relative to the discovery signal position;
WUS time and/or frequency resources;
WUS subcarrier spacing;
a WUS transmission window length.

62. The method of claim 48, wherein the WUS configuration is based on one or more parameters associated with the discovery signal, including one or more of:
a sequence index of a sequence found in the discovery signal;
a discovery signal raster position index;
a discovery signal format.

63. The method of claim 48, wherein the discovery signal has a format with sequence-encoding.

64. A method performed by a network node, the method comprising:
transmitting a discovery signal; and
receiving a wake-up signal, WUS, transmitted in accordance with a WUS configuration, wherein the WUS configuration is based on the discovery signal, wherein the WUS configuration comprises one or more of:
a WUS permitted indicator or flag;
a number of WUS attempts to be made if the network node does not respond to the WUS;
a periodicity to be used for WUS attempts if the network node does not respond to the WUS;
a prohibition timer to be applied before making a second attempt to transmit the WUS if the network node does not respond to the WUS;
a response time/window during which to receive a response to the WUS.

65. The method of claim 64, wherein the discovery signal is provided in a different beam and/or with a different periodicity than a synchronization signal block, SSB, specified in NR Release 15.

66. A wireless communication device comprising:
processing circuitry; and
power supply circuitry configured to supply power to the processing circuitry,
wherein the processing circuitry is configured to:
receive a discovery signal; and
transmit a wake-up signal, WUS, based on a WUS configuration, wherein the WUS configuration is based on the discovery signal, wherein the WUS configuration comprises one or more of:
a WUS permitted indicator or flag;
a number of WUS attempts to be made if a network node does not respond to the WUS;
a periodicity to be used for WUS attempts if a network node does not respond to the WUS;
a prohibition timer to be applied before making a second attempt to transmit the WUS if a network node does not respond to the WUS;
a response time/window during which to receive a response to the WUS.

67. A network node comprising:
processing circuitry; and
power supply circuitry configured to supply power to the processing circuitry,
wherein the processing circuitry is configured to:
transmit a discovery signal; and
receive a wake-up signal, WUS, transmitted in accordance with a WUS configuration, wherein the WUS configuration is based on the discovery signal, wherein the WUS configuration comprises one or more of:
a WUS permitted indicator or flag;
a number of WUS attempts to be made if the network node does not respond to the WUS;
a periodicity to be used for WUS attempts if the network node does not respond to the WUS;
a prohibition timer to be applied before making a second attempt to transmit the WUS if the network node does not respond to the WUS;
a response time/window during which to receive a response to the WUS.
